(19) United States
(12) Patent Application Publication
(10) Pub. No.: US 2014/0006259 A1
(43) Pub. Date: Jan. 2, 2014

(54) SYSTEM FOR ITEM LEVEL PAYMENT VEHICLE SUGGESTION

(71) Applicants: David M. Grigg, Rock Hill, SC (US); Matthew A. Calman, Charlotte, NC (US); Susan Smith Thomas, Gastonia, NC (US); Elizabeth S. Votaw, Potomac, MD (US); Alicia C. Jones, Fort Mill, SC (US); Peter John Bertanzetti, Charlotte, NC (US)

(72) Inventors: David M. Grigg, Rock Hill, SC (US); Matthew A. Calman, Charlotte, NC (US); Susan Smith Thomas, Gastonia, NC (US); Elizabeth S. Votaw, Potomac, MD (US); Alicia C. Jones, Fort Mill, SC (US); Peter John Bertanzetti, Charlotte, NC (US)

(73) Assignee: BANK OF AMERICA CORPORATION, Charlotte, NC (US)

(21) Appl. No.: 13/536,466

(22) Filed: Jun. 28, 2012

(51) Int. Cl. G06Q 20/22

(52) U.S. Cl. 705/39

(57) ABSTRACT

Embodiments of the present invention allow a user to use multiple different payment vehicles in a single transaction to purchase a variety of different items wherein the different payment vehicles are chosen because of favorable payment terms associated with a category assigned to the item by receiving information about a transaction, assigning the items in the transaction to at least one category, determining a payment vehicle to use in completing the transaction for each item and using the communication device to transmit to the transaction device the information related to the payment vehicles determined for use in completing the transaction for each item.

### BACKGROUND

There is a need for systems, apparatuses and methods that lessen the burden associated with carrying credit cards, checks, cash, and other payment vehicles while maximizing the benefits of using different payment vehicles to purchase different categories of goods and services.

### BRIEF SUMMARY

Embodiments of the present invention address the above needs and/or achieve other advantages by providing apparatuses (e.g., systems, computer program products, and/or other devices) and methods that allow a user to use multiple different payment vehicles in a single transaction to purchase a variety of different items and wherein the different payment vehicles are chosen because of favorable payment terms associated with a category (e.g. electronics, food, education, entertainment, business expense etc.) assigned to the item. For example, in some embodiments, a user will present a mobile device with a mobile wallet application stored thereon that will analyze the items in a transaction, categorize each of the items, determine what payment vehicle has the most favorable payment terms for each item and then wirelessly complete the transaction.

In particular, according to various embodiments, a system is provided that includes a user interface configured to receive input from a user and to display information to the user, a communication device configured to transmit and receive information from a transaction device (e.g. a point-of-sale device, mobile device configured for peer-to-peer transfer etc.), a memory comprising information related to more than one payment vehicles stored therein and a processor communicably coupled to the user interface, the communication device and the memory. In some such embodiments, the processor is configured to operate computer instruction code to receive information about items in a transaction, wherein the information comprises item level information about items in the transaction, assign the items in the transaction to at least one category based in part on the item level information about the items, determine a payment vehicle to use in completing the transaction for each item based in part on the category assigned to the items and use the communication device to transmit to a transaction device the information related to the payment vehicles determined for use in completing the transaction for each item. In certain embodiments, receiving information about a transaction (and/or using the communication device to transmit information related to the payment vehicles to the transaction device) is accomplished by near-field communication, radio frequency identification, wireless communication protocols, quick response (“QR”) codes, universal product codes, bar codes or magnetic codes.

In certain embodiments, assigning the items in the transaction to at least one category comprises receiving a category designation for the items from a merchant. In other embodiments, assigning the items being purchased to a category involves presenting to the user, via the user interface, the item level information about the items being purchased and receiving inputs from the user assigning the items to one or more categories. In certain embodiments, assigning the items in the transaction to a category comprises using the item level information about the items in the transaction to associate the items with a category in a preexisting database. In yet other embodiments, assigning the items in the transaction to at least one category comprises determining the location of the transaction (e.g. by using a positioning device) and using the transaction location and the item level information about the items in the transaction to assign the items to at least one category.

Consistent with certain embodiments, determining a payment vehicle to use in completing the transaction for each item may involve comparing the assigned categories to predetermined user defined preferences about the payment vehicles to use for different categories of items. In other embodiments, determining a payment vehicle to use in completing the transaction for each item comprises analyzing the payment terms associated with the payment vehicles available to the user and identifying payment terms that correspond favorably to items in at least one category. In some such embodiments, payment terms may include, but are not limited to, reward terms, cash back terms, credit rates, merchant terms, product warranty terms, dispute resolution terms, consumer protection regulations, transaction costs, terms regarding protection against misappropriation of information, membership assessments, regulatory terms or incentives.

In certain embodiments, using the communication device to transmit to the transaction device the information related to the determined payment vehicles comprises, presenting information to the user via the user interface about the payment vehicle determined for use in completing the transaction for each item, receiving input from the user approving the completion of the transaction using the determined payment vehicle for each item or assigning an alternate payment vehicle for use with one or more items and using the communication device to transmit the information related to the approved payment vehicles to complete the transaction. Consistent with embodiments of the present system, using the communication device to transmit to the transaction device the information related to the determined payment vehicles involves only a single transaction without respect to the number of different payment vehicles used.

According to particular embodiments, a computer program product is provided comprising a non-transitory computer readable medium with computer-executable code stored thereon, the computer-executable code comprising a first code portion configured to receive information about items in a transaction, wherein the information comprises item level information about items in the transaction, a second code portion configured to assign the items the transaction to at least one category based in part on the item level information about the items, a third code portion stored in the memory and configured to determine a payment vehicle to use in completing the transaction for each item based in part on the category assigned to the items and a fourth code portion stored in the memory and configured to transmit to the transaction device information related to the payment vehicles determined for use in completing the transaction for each item.

In some such embodiments, the first code portion is configured to receive information about a transaction (and the fourth code portion is configured to transmit information to the transaction device) through the use of near-field communication, radio frequency identification, wireless communication protocols, QR codes, universal product codes, bar codes or magnetic codes.

According to some embodiments, the second code portion is configured to assign the items in the transaction to at least one category by receiving a category designation for the items from a merchant. In other embodiments, the second code portion is configured to assign the items in the transaction to at least one category by presenting the user with the item level information about the items in the transaction and receiving inputs from the user assigning the items to one or more categories. In yet other embodiments, the second code portion is configured to assign the items in the transaction to at least one category by using the item level information about the items in the transaction to associate the items with a category in preexisting databases. In still yet other embodiments, the second code portion is configured to assign the items in the transaction to at least one category by determining the location of the transaction and using the location of the transaction and the item level information about the items in the transaction to assign the items to at least one category.

In certain embodiments the third code portion, in determining a payment vehicle to use in completing the transaction for each item based in part on the category assigned to the items, is further configured to compare the assigned categories to predetermined user defined preference about what payment vehicle to use for different categories of items. In other embodiments the third code portion is configured to determine a payment vehicle to use in completing the transaction for each item based in part on the category assigned to the items by analyzing the payment terms associated with the payment vehicles available to the user and identifying payment terms that correspond favorably to items in at least one category. Consistent with such embodiments, payment terms may include reward terms, cash back terms, credit rates, merchant terms, product warranty terms, dispute resolution terms, consumer protection regulations, transaction assessments, terms regarding protection against the misappropriation of information, membership assessments, regulatory terms or incentives.

In certain embodiments, the fourth code portion is configured to transmit to the transaction device information related to the payment vehicles determined for use in completing the transaction for each item by presenting information to the user, via a user interface, about the payment vehicle determined for use in completing the transaction for each item, receive input from the user approving the completion of the transaction using the determined payment vehicle for each item or assigning an alternate payment vehicle for use with one or more items and transmitting to the transaction device the information related to the approved payment vehicles to complete the transaction.

Certain embodiments of the invention also include a method for categorizing items in a transaction and selecting a payment vehicle with favorable payment terms to complete the transaction, comprising storing information related to more than one payment vehicles in the memory of a mobile device, presenting the mobile device proximate to a transaction device, receiving information about a transaction from the transaction device, wherein the information comprises item level information about items in the transaction, sorting the items being purchased into at least one category, correlating the category of items to favorable payment terms associated with the more than one payment vehicles stored in the memory of the mobile device, suggesting payment vehicles with the most favorable payment terms for each item, receiving, via the mobile device, user input assigning a payment vehicle for use in the completion of the transaction and completing the transaction by communicating the information related to the payment vehicles indicated by the received user input.

In some such embodiments, communicating the information related to the transaction or the payment vehicles is completed through the use of near-field communication, radio frequency identification, wireless communication protocols, QR codes, universal product codes, bar codes or magnetic codes.

Consistent with certain embodiments, correlating the category of the items to favorable payment terms further comprises identifying payment terms for the more than one payment vehicles stored in the memory of the mobile device that vary according to the category of the item being purchased, comparing the payment terms for each of the more than one payment vehicles for each of the items in the transaction and determining the payment vehicle with the most favorable payment terms for each of the items in the transaction. In other embodiments, correlating the category of the items to favorable payment terms associated with the more than one payment vehicles stored in the memory comprises receiving user defined preferences regarding which payment vehicles to use for different categories of items.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 provides a block diagram illustrating a system for providing item level payment vehicle suggestions, in accordance with an embodiment of the present invention.

FIG. 2 provides a flow diagram illustrating a process flow for providing item level payment vehicle suggestions, in accordance with an embodiment of the present invention;

FIG. 3 provides a flow diagram illustrating a process flow for assigning the items in the transaction to at least one category, in accordance with an embodiment of the present invention;

FIG. 4 provides a flow diagram illustrating a process flow for determining a payment vehicle to use in completing the transaction for each item based in part on the category assigned to the item, in accordance with embodiments of the present invention;

FIG. 5a provides a flow diagram illustrating a process flow for providing item level payment vehicle suggestions, in accordance with an embodiment of the present invention;

FIG. 5b provides a flow diagram illustrating a process flow for providing item level payment vehicle suggestions, in accordance with an embodiment of the present invention;

FIG. 6 provides an example of a display page associated with the system for providing item level payment vehicle suggestion, in accordance with one embodiment of the present invention;

FIG. 7 provides an example of a display page associated with the system for providing item level payment vehicle suggestion, in accordance with one embodiment of the present invention; and

FIG. 8 provides an example of a display page associated with the system for providing item level payment vehicle suggestion, in accordance with one embodiment of the present invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Mobile electronic wallets (also sometimes referred to herein simply as “mobile wallets”) have been proposed and created by the inventors and assignee of the present invention. A mobile electronic wallet is a mobile phone or similar device that can store information about a plurality of payment vehicles (e.g., credit cards, debit cards, gift cards, investment accounts, savings accounts, and/or the like) associated with the user and wirelessly transmit information about a selected payment vehicle to a point-of-sale terminal or other transaction devices to engage in a transaction using the selected payment vehicle. Mobile electronic wallets allow a user to conveniently carry multiple payment vehicles (e.g., electronic credit cards, debit cards, gift cards, coupons, and/or the like) in a device that the user already carries with them at all times, such as a mobile phone.

Consistent with certain embodiments of the present invention, a mobile wallet is provided that will receive information about the items being purchased in a transaction, place each item into one or more categories and then determine a payment vehicle available to the user to use in connection with the completion of the transaction, wherein the selected payment vehicle has favorable payment terms relating to the category of the item being purchased.

It will be understood that “item” or “items” as used herein in relation to a transaction shall mean any product, good, service, event, right of access etc. that may be offered for sale by a merchant. A “merchant” as used herein may refer to a person, business, manufacturer, retailer, service provider, event provider, warehouse supplier and/or the like. Further, the embodiments described herein may refer to a transaction. Unless specifically limited by the context, a “transaction” refers to any communication between the user and a merchant, financial institution or other entity. For example, in some embodiments, a transaction may include one or more of the following: purchasing, renting, bartering, selling and/or leasing goods and/or services; withdrawing cash; making payments to creditors; sending remittances; transferring balances from one account to another account; loading money onto stored value cards and/or prepaid cards; donating to charities and/or the like. “Transaction information” as used herein, includes, but is not limited to the name of the individual or entity with whom the transaction is entered, the cost of the transaction, the date of the transaction, the time of the transaction, the location of the transaction and item level information about the items being purchased (i.e. nature, type, quantity, style, size, specifications, etc.). Embodiments described herein may also refer to information about or related to the one or more payment vehicles. As used herein, information about payment vehicles may include any information needed by the transaction device, merchant, financial institution, etc. to complete a transaction, including, without limitation, account numbers, account holder information (e.g. name, address, etc.) security numbers, pin numbers, information about the payment vehicle issuer etc.

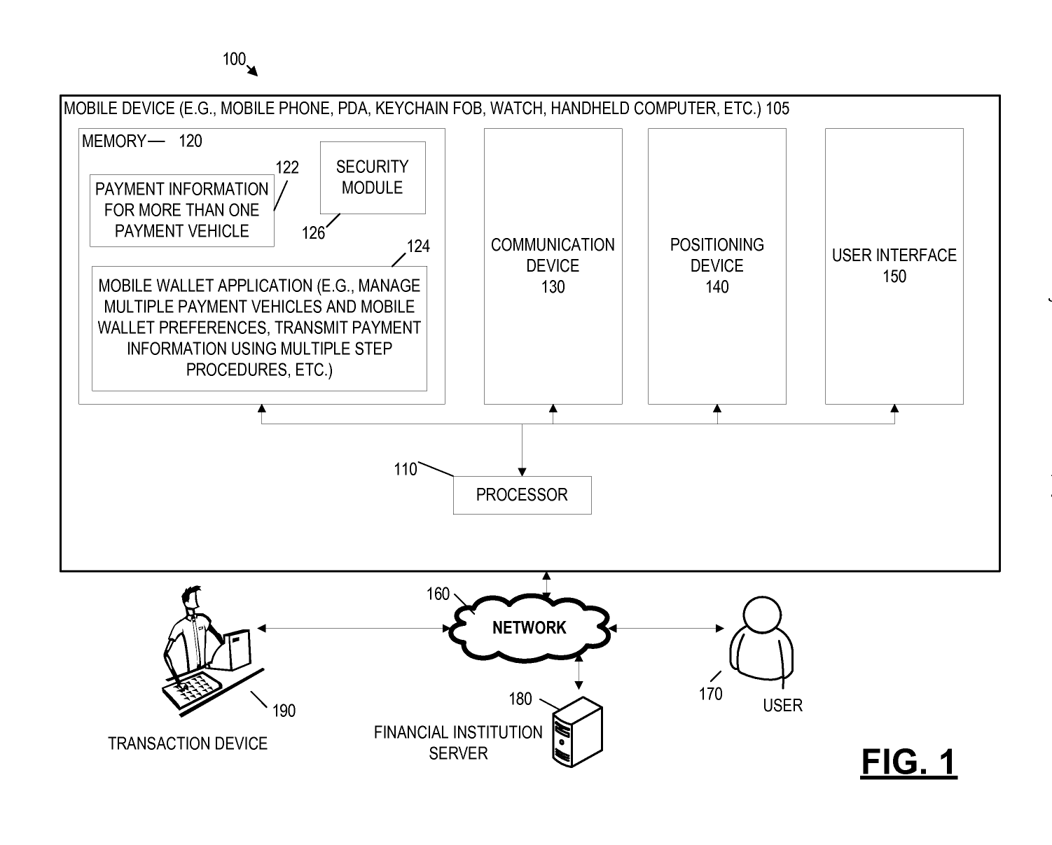

FIG. 1 provides a block diagram illustrating a system for providing item level payment vehicle suggestions 100 in a mobile commerce environment, in accordance with one embodiment of the present invention. In some embodiments, the system 100 includes a mobile device 105 such as a mobile phone, PDA, handheld computer, key FOB etc. The mobile device 105 may include a processor 110, a memory 120, a communication device 130, a positioning device 140, such as a Global Positioning System and a user interface 150, such as a touch screen, display and keypad etc. The system 100 also generally includes a user 170, a financial institution server 180, and a transaction device 190, (which may be any type of transaction device, such as a point-of-sale terminal, an ATM, another mobile device, and/or the like) all selectively and communicably coupled via a network 160.

The processor 110, generally includes circuitry or executable code for implementing the audio, visual, and/or logic functions of the mobile device 105. For example, the processor may include a digital signal processor device, a microprocessor device, and various analog-to-digital converters, digital-to-analog converters, and other support devices. Control and signal processing functions of the system in which the processor resides may be allocated between these devices according to their respective capabilities. The processor 110 may also include functionality to operate one or more software programs based at least partially on computer-executable program code portions thereof, which may be stored, for example, in a memory device, such as the memory 120 of the mobile device 105.

The memory 120, may include any computer-readable medium. For example, memory may include volatile memory, such as volatile random access memory (RAM) having a cache area for the temporary storage of data. Memory 120 may also include non-volatile memory, which may be embedded and/or may be removable. The non-volatile memory may additionally or alternatively include an EEPROM, flash memory, and/or the like. The memory 120 may store any one or more pieces of information and data used by the mobile device 105 to implement the functions of the system 100. In some embodiments, as illustrated in FIG. 1, payment information for more than one payment vehicle 122 and a mobile wallet application 124 may be stored in memory 120. The payment information for more than one payment vehicle 122 may include any information needed to process a financial transaction using a payment vehicle (e.g. credit card, debit card, store issued card, gift card, loyalty card, savings account, checking account, investment account, line of credit etc.). Such information may include, but is not limited to account numbers, security numbers, account holder information (i.e. name, billing address etc.) and issuer information (e.g. the name and contact information for the financial institution that issued the credit card, debit card or the like). In certain embodiments, the payment information for more than one payment vehicle 122 is collected and stored in the memory 120 as part of the operation of the mobile wallet application 124. In some such embodiments, the payment information is manually inputted by the user. In other embodiments, the payment information is automatically collected by the mobile device 105 and/or the mobile wallet application 124. For instance, the mobile wallet application 124 may automatically collect information regarding the financial vehicles available to the user. Such information may be collected, for example, by connecting to the financial institution server 180 over the network 160 to identify the payment vehicle information for all payment vehicles held by the user 170 with the financial institution that owns and operates the financial institution server 180. The mobile wallet application 124 may include any software, application or computer program product featuring code to store and manage information relating to multiple payment vehicles and transmit and receive information necessary to complete a transaction. A user 170 may download the mobile wallet application 124 from a server to the mobile device 105. Alternatively, the mobile device 105 may come with the mobile wallet application 124 preloaded on the memory 120 of the mobile device 105. The user may then store payment vehicle information 122 in a secure section of the memory 120 of the mobile device 105. In certain embodiments, the mobile wallet application 124 can be configured to implement one or more portions of the process flows described and/or contemplated herein. For instance, the mobile wallet application 124 may include the ability to store user preference information regarding payment vehicles and/or include the functionality to analyze and categorize products and recommend payment vehicles consistent with the invention described and/or contemplated herein.

The memory 120, in certain embodiments may include a security module 126 configured to maintain the security of the user's 170 payment vehicle information 122 on the mobile device 105 and during a transaction. The security module 126 contains data encryption software for protecting the payment vehicle information 122 in the memory 120 of the mobile device 105. A wide variety of encryption techniques are available for protecting data on a mobile device 105. In another embodiment, the security module 126 establishes a secure connection with the transaction device 190. A secure connection is a connection that an unauthorized third party is unable to gain access to. In some embodiments, the secure connection is established solely by the mobile device 105. In other embodiments, the secure connection is established by the mobile device 105 in cooperation with the transaction device 190. In a still further embodiment, the security module 126 controls security related to the user interface 150. For example, the security module 126 may encrypt the user's personal input data, such as security codes or pin numbers, so that third parties may not copy or view this information. In addition, in some embodiments, the security module 126 evaluates the number of times the user 170 has unsuccessfully attempted to authorize the transaction and locks the user 170 out after a certain number of failed attempts. For example, the user may attempt to authorize a transaction by logging into the mobile wallet application 124. If the incorrect username and password is provided, the security module 126 will not authorize the transaction. The security module 126 can recognize this failure and if it happens a predetermined number of times, such as three times, the security module 126 can lock the mobile device 105 down for security purposes. In other embodiments, instead of locking the mobile device 105 down, the security module 126 requires enhanced authentication procedures such as entry of a challenge question etc.

The communication device 130, generally includes hardware, and, in some instances, software, that enables the mobile device 105 to transport, send, receive, and/or otherwise communicate information to or from other communication interfaces. For example, the communication interface 130, may include a modem, server, electrical connection and/or other electronic devices that operatively connect the mobile device 105 to another electronic device, such as the transaction device 190. As a further example, the communication device 130 may include hardware, such as a scanner, bar code display, magnetic strip reader, etc. and/or software to enable to the mobile device 105 to transmit and receive information via one or more wireless information protocols, such as near-field communication, radio frequency identification, wireless protocols, Bluetooth, QR codes, universal product codes, bar codes and/or magnetic codes.

The positioning device 140, may include any hardware or software necessary to identify the present location of the mobile device 105 in real-time or near real time, such as via cellular phone signals, cell tower access, wireless network access, GPS signals and the like. Such a positioning device 140 may include, but is not limited to a Global Positioning System.

The user interface 150 may include one or more user output devices, such as a display and/or speaker, for presenting information to the user 170. In some embodiments, the user interface 150 includes one or more user input devices, such as one or more buttons, keys, dials, levers, directional pads, joysticks, accelerometers, controllers, microphones, touch pads, touch screens, haptic interfaces, microphones, scanners, motion detectors, cameras, and/or the like for receiving information from the user 170. In some embodiments, the user interface 150 includes the input and display devices of a personal computer, such as a keyboard and monitor, that are operable to receive and display information associated with various payment vehicles and/or the items being purchased in a transaction. In some embodiments, the user interface includes the input and display devices of a mobile device (e.g. smartphone, PDA, etc.), such as a display and touch screen or keypad, that are operable to receive and display information associated with various payment vehicles and/or the items being purchased in a transaction.

As shown in FIG. 1, the mobile device 105, the transaction device 190 and/or the financial institution server 180 are each operatively and selectively connected to the network 160. The network 160 may be a global area network (GAN), such as the Internet, a wide area network (WAN), a local area network (LAN), a WIFI network, a third-generation (3G) or fourth-generation (4G) network, or any other type of network or combination of networks. The network 160 may provide for wireline, wireless, or a combination of wireline and wireless communication between devices on the network. The network 160 may include several networks including a mobile telephone network, a local wireless payment network, a global payment transaction network, and perhaps the Internet. It will also be understood that the network 160 may be secure and/or unsecure and may also include wireless and/or wireline technology.

The system for providing item level payment vehicle suggestions 100 is depicted in a mobile commerce environment including the user 170 of the mobile device 105, one or more financial institution servers 180, and one or more transaction devices 190. In some embodiments, the user 170 is a customer of a financial institution. For example, the user 170 may be a customer of a bank and link the user's bank accounts (which may be accessible via the financial institution server 180) to the user's mobile device 105. In another embodiment, the user 170 is not a customer of a financial institution.

The transaction device 190, may include any device that is capable of receiving and transmitting transaction information, payment vehicle information and the like in order to complete a transaction (e.g. a sale, return, transfer etc.). For example, the transaction device 190 may be a point-of-sale device maintained by a merchant, an ATM maintained by a financial institution, a mobile device, a computer platform and/or the like selectively and operatively connected to the mobile device 105 over the network 160.

In some embodiments, the transaction device 190 is configured to complete the transaction using a standard global payment network and transaction processing system. For example, once the user's payment information is transferred to the transaction device 190, the transaction device 190 completes the transaction in a similar manner to current credit card and debit card transactions. In such embodiments, the transaction device 190 communicates with the financial institution server 180 to determine whether sufficient funds are available to complete the transaction.

The financial institution server 180 is a computer system associated with a bank, credit union, or other provider of financial services. The financial institution server 180 contains information relating to the user's payment vehicles, such as the user's account number, account balances, transaction history, and account limits. The financial institution server 180, in certain embodiments, may also contain information regarding the payment terms (e.g. reward terms, cash back terms, warranty terms, return terms etc.) associated with a payment vehicle available to the user 170. The financial institution server 180 may be accessed in order to download payment information and account information to the mobile device 105, to provide information regarding payment terms for a payment vehicle, and/or to request authorization for a transaction, as described in greater detail below.

It is understood that the systems, servers and devices described herein illustrate one embodiment of the invention. It is further understood that one or more of the systems, servers and devices can be combined in other embodiments and still function in the same or similar way as the embodiments described herein.

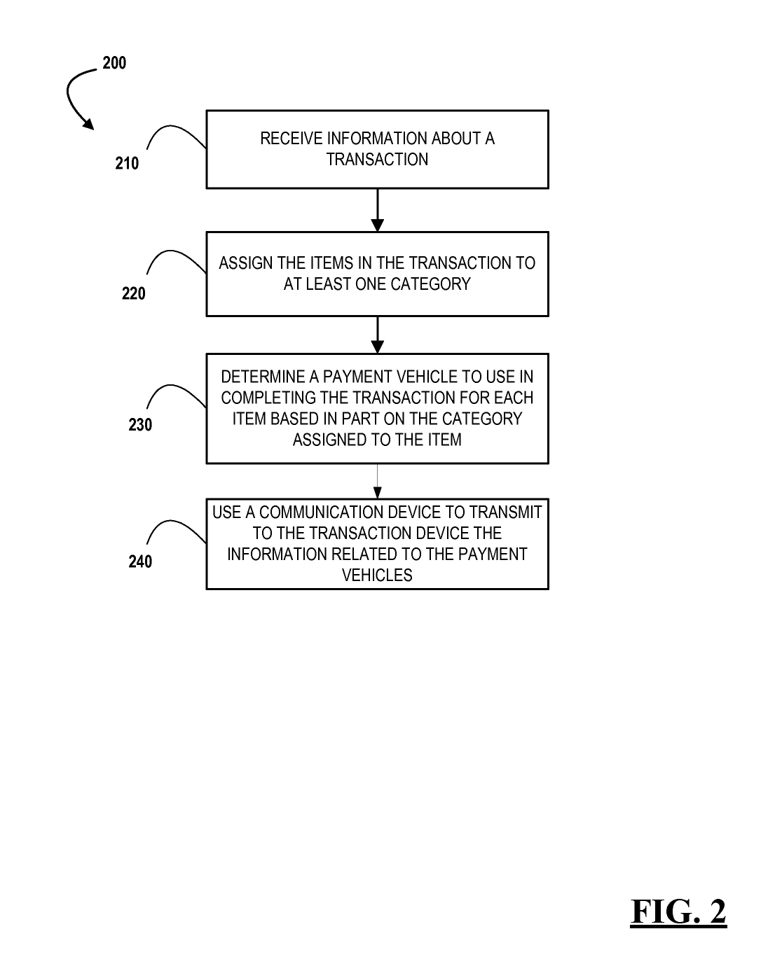

FIGS. 2-5 described below, illustrate process flows for providing item level payment vehicle suggestions. It will be understood that the system 100 and the mobile device 105 described above may be used in performing one or more of the steps described in the process flows illustrated in FIGS. 2-5. It should also be understood that the steps performed, in some cases, may be performed in a different order than the order shown, may be performed by different actors, or may not be performed at all. These figures depict only specific embodiments of the invention but do not limit the invention to the described steps.

FIG. 2. provides a flow diagram illustrating a process flow 200 for providing item level payment vehicle suggestions, in accordance with an embodiment of the present invention. As illustrated by block 210, in certain embodiments a processor or a computer program product is configured to receive information about items in a transaction. It will be understood that such information will include any information needed to complete the purchase, sale, transfer, exchange or the like of any item. Transaction information may include, but is not limited to, the identity of the merchant or person, the identity of the items being sold, the price of the items, the time, date and location of the transaction etc. In certain embodiments, the transaction information will include item level information about the products being purchased. Such item level information may include a description of the item, its price, size, specifications, make-up, ingredients, materials, serial number, model number or other identification number, color, location of manufacture, date of manufacture, and the like. The information about a transaction may be received in any manner suited for the purpose. For instance, the information about a transaction may be communicated wirelessly from a near-field communication device or a radio frequency identification device and received by a mobile device configured to receive such communications. The information may also be received through wireless communication protocols, such as WIFI or the like. The transaction information may also be received through the scan of a QR code, bar code, UPC code or via a magnetic code reader, for instance, incorporated in a mobile device. In some instances, the transaction information will be transmitted from a transaction device, such as a point of sale device, merchant interface or the like. In other instances, the transaction information may be scanned by the user's mobile device. For instance, a user may scan a QR code or bar code on the products in her shopping cart or on the shelves at a merchant location.

As illustrated by block 220, the items in the transaction are assigned to at least one category. A category may be any set of classes or divisions within which the items can be associated. For example, item categories may include appliances, automotive, childcare, beauty, home, office supplies, books, electronics, computers, clothing, leisure, entertainment, fitness etc. In some embodiments, the available categories within which an item may be classified will be predetermined. In other embodiments, a user may be able to define the item categories or suggest additional or alternate categories. In certain embodiments, items will be assigned to a category based at least in part on the item level information associated with the item. For instance, if the information received about a transaction 210 indicates the items being purchased are a forty-two inch television, a DVD player and a book on computer programming, the items being purchased may be categorized, for example, in electronics, electronics and books, respectively. It will be understood that a given item may be categorized in more than one category. For example, a book could be categorized in leisure, education, books, office supplies, etc. The foregoing examples are provided as illustrations and should not be interpreted in any way as limiting the type of categories in which a given item may be assigned.

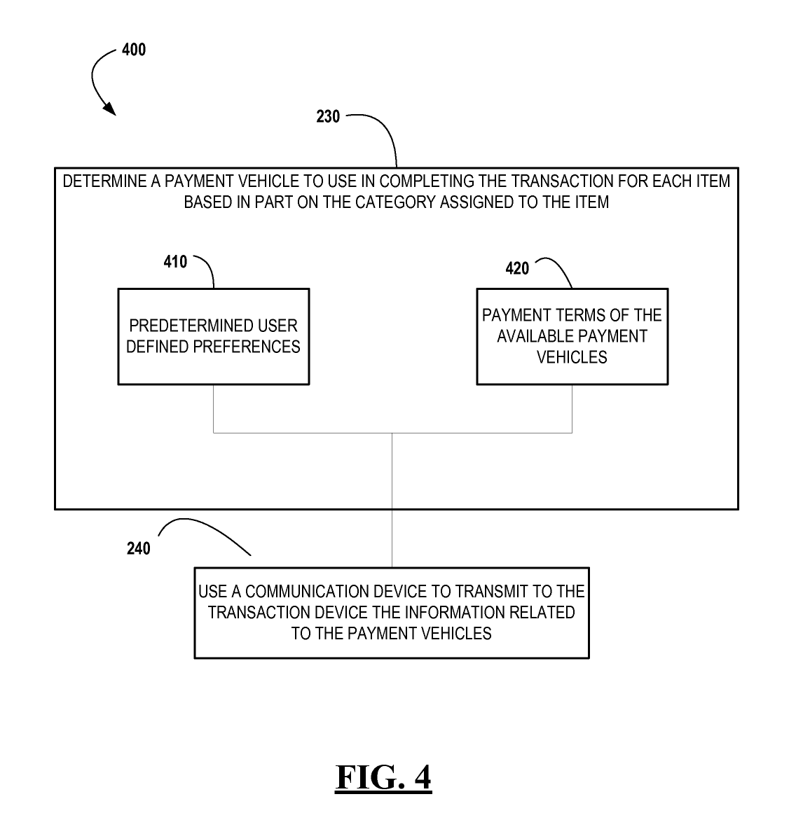

Once each item is assigned to at least one category, the process 200 moves to block 230, wherein a payment vehicle is determined to use in completing the transaction for each item based in part on the category assigned to each item. It will be understood that different payment vehicles may be used in connection with the purchase of different items. For instance, in a transaction involving the purchase of gasoline, convenience food items and a gallon of milk, a credit card may be used for the purchase of the gasoline, a store issued loyalty card for the purchase of the convenience food items and a debit card for the purchase of the gallon of milk. The payment vehicle used in connection with each item may be based on the category of item as discussed in greater detail in connection with FIG. 4. Regardless of the number of payment vehicles used to complete the transaction, in certain embodiments, the transaction will proceed and be processed as a single transaction.

After a payment vehicle is determined for each item, as shown at block 240, the information related to the payment vehicles is communicated to a transaction device to complete the transaction. Such communication can occur in any manner sufficient to approve payment from the identified payment vehicles and transfer currency, funds, credit etc. from the user's account to a merchant or vice versa. For instance, the payment information may be communicated to a transaction device using near-field communication, radio frequency identification, wireless communication protocols or the like. Further, the payment information may be communicated by generating a unique QR code, bar code or magnetically stored code to be scanned or read by a transaction device. In some embodiments, this communication will involve operatively connecting to a financial institution server or otherwise receiving authorization for payment from the financial institution associated with the payment vehicles being used. In other embodiments, the information necessary to complete the transaction may be available without separately contacting or receiving approval from the financial institution.

In some instances, determining a payment vehicle to use in completing the transaction for each item based in part on the category assigned to the item 230 may occur after an initial point-of-sale transaction. For instance, there may be some delay between an initial transmission of payment information and the resulting transfer of funds from the user's accounts to a merchant (financial institution, other person or the like). This delay may enable a user to identify alternate payment vehicles to use to complete the transaction. Accordingly, all of the steps of process flow 200 in FIG. 2 may actually take place after an initial payment instructions have occurred. For instance, a user may use a mobile wallet to complete a transaction using Debit Card#1, e.g. presenting a mobile wallet at a point-of-sale terminal to purchase a number of grocery items and a flat panel television. After the transaction has been completed, the system may analyze the item level information about the items 210 just purchased and assign the items to a category (i.e. groceries and electronics) 220. The mobile device may determine that the user should have used Credit Card#1 instead of Debit Card#1 to complete the transaction for the purchase of the television 230. The user may then use the mobile device to transmit this alternate payment information to a transaction device and thereby complete the transaction using alternate payment vehicles. In some such embodiments, the user may use the receipt from the initial point-of-sale transaction to collect item level information about the items in the transaction. For instance, the user may use the mobile device to take an image of the receipt and the mobile device may analyze the information on the receipt, such as stock keeping units (SKUs), descriptions, price and the like to assign the items to a category. Similarly, an electronic receipt may be communicated to the mobile device (e.g. via the user's e-mail account) and the mobile device may analyze the contents of the electronic receipt to categories the purchased items.

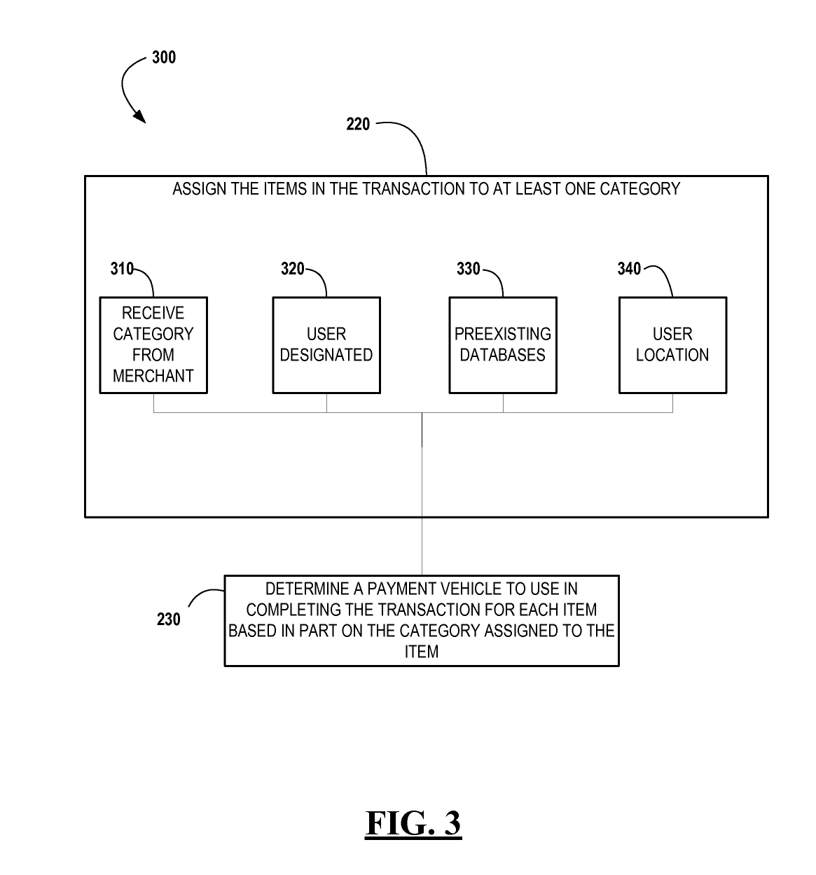

Referring now to FIG. 3 a process flow diagram is provided illustrating a process flow 300 for assigning the items in the transaction to at least one category, in accordance with an embodiment of the present invention. As shown at block 310 the items may be assigned to at least one category based in part on a category designation provided by the merchant. For instance, a merchant as part of its inventory processes, sales tracking, logistics systems, compliance with government regulation (such as WIC) and/or the like may classify the items it sells into different categories. Such category information may be included in the item level transaction information received from a transaction device (FIG. 2. at block 210). In such cases, the item may be assigned to the category designated by the merchant. Alternatively, the designation assigned by the merchant may be considered along with other item level information and/or other determinants to assign the item to a category.

As illustrated at block 320, items may also be assigned to at least one category by the user. For instance, the item level information about the items being purchased may be presented to a user on a user interface (such as the touch screen of a mobile phone) and the user will be able to use the user interface to assign each item to one or more categories. In certain embodiments, the user will be required to assign each item to a list of predetermined categories. In other embodiments, the user may be able to create user defined categories for the items and assign items to those categories. The user may assign items to different categories by establishing predetermined rules and the items will be assigned according to such rules. For example, when setting up the mobile wallet application discussed and contemplated herein (see e.g. FIG. 1 at 124) the user may be prompted to review a variety of potential goods and assign such goods to preferred categories. The mobile wallet application, in such an example, may then use the user's preferences to assign items in connection with future transactions. In such embodiments, where the user provides predetermined preferences, if the system encounters an item not specifically pre-assigned to a category by the user, the system may extrapolate the user's preferences from the other predetermined category assignments. Alternatively, in such an instance, the user may be prompted to provide a category for the new type of item.

Block 330 illustrates that items may be assigned to a category by associating the item level information about the items being purchased to preexisting databases relating to the categorization of goods. For instance, a financial institution, merchant or third-party vendor may create databases of different types of items and classify the various items into different categories. In such an instance, when the item level information about the items being purchased is received, the items being purchased can be compared to the information in the existing databases to identify a category for each item. In some embodiments, the existing databases may not be specifically created for use in connection with the systems and computer program products described and contemplated herein but may currently exist for other purposes. For instance, the existing database may be a website accessible via the Internet in which products or services are categorized by a merchant for sale (such as within different departments in an online retail store). In such an embodiment, the items being purchased may be assigned to at least one category by comparing the item level information of the item being purchased to the categories of items used in the third-party website. In certain embodiments, multiple databases may be considered and compared to identify a suitable category for each item being purchased.

As illustrated at block 340, the category assigned to the items being purchased may be determined in part according to the user's location. For example, if a user is using a mobile device to complete a wireless transaction, a positioning device, such as a GPS device within the mobile device may determine that the user is at specific coordinates, which correspond to an address for a specialty home goods store. When the item level information associated with the items being purchased is consistent with home goods, the items may be categorized as home goods based on the combination of the item level information and the location of the transaction. As another example, the item level information about a product being purchased may indicate that a user has purchased a book. Based on this information alone, the book may be appropriately categorized in leisure, education, office supplies etc. However, consistent with certain embodiments, a positioning device, may locate the transaction involving the purchase of the book as taking place in a book store at a local university. This additional information may be combined with the item level information to assign the item being purchased to, for example, a school supplies category.

Once each of the items in the transaction is assigned to at least one category, a payment vehicle is determined to use in completing the transaction for each item 230. Referring to FIG. 4, a flow diagram illustrating a process flow 400 is provided for determining a payment vehicle to use in connection with the purchase of each item based in part on the category assigned to the item, in accordance with embodiments of the present invention As illustrated by block 410, the payment vehicle to be used in connection with individual items may be determined according to predetermined user defined preferences. In such embodiments, the user, for example, may be required to set her preferences when she initially sets up the mobile wallet application and stores information associated with more than one payment vehicles in the memory of a mobile device. For instance, if the user stores information associated with a credit card in the memory of the mobile device, the user may know that the credit card offers additional cash back rewards for purchases of gasoline or groceries. Accordingly, the user may indicate that she prefers to use that credit card for items categorized as gasoline or groceries. In another example, the user may receive a gift card which expires after a period of time so the user can indicate that she prefers to use the gift card in connection with all possible categories of purchases if possible. It will be understood that while these user preferences may initially be set during the set-up of a mobile wallet, or the like, that these preferences may also be set or altered at any time prior to the completion of the transaction. For instance, in some embodiments, the user may be presented with information regarding the category of the item being purchased and have an opportunity to assign a specific payment vehicle to be used in connection with the purchase at the time of the transaction. In some such embodiments, the user may indicate that she wants to use a specific payment vehicle to pay for certain items (or categories of items) but all other items may be paid for using a default payment vehicle or the payment vehicle determined by the system. Similarly, the user may be able to override a predetermined user defined preference while authorizing the completion of the transaction. For example, if the user had previously indicated that she wanted to use a credit card for the purchase of all electronics but was recently enrolled in favorable rewards program by a financial institution for using a specific debit card, the user may be able to select the debit card for use in completing the transaction despite the prior choice of the credit card.

As shown at block 420, the determination of what payment vehicle to use may also be done automatically according to the payment terms of the available payment vehicle. As used herein, payment terms include any contractual terms, regulations, agreements, terms of use and the like that relate to the manner in which funds are provided to a user (including any assessments or rates required to access the funds), the incentives offered to a user for using a particular payment vehicle, limitation on use, or the like.. Payment terms include, but are not limited to, reward terms. Reward terms may be any type of incentive provided to a user for using a payment vehicle, such as frequent flyer miles, travel points, store credit, discount offers, and the like. Similarly, payment terms may include cash back terms, wherein a user is offered a credit of a certain percentage of the total purchases made using the payment vehicle. Payment terms may also include the rate at which a financial institution or credit card provider is willing to extend credit to a user and any of the repayment requirements associated therewith. Payment terms may further include merchant specific terms such as limitations on where a payment vehicle can be used, special deals such as 10% off during a limited period, etc. Another example of a payment term is any product warranty, product protection or product return terms. For instance, many credit card providers offer certain refund or return guarantees if a product purchased using the credit card turns out to be defective. A payment term may also include dispute resolution terms. For instance, a payment vehicle may offer to refund an amount paid by the user if a merchant fails to provide the products or services offered or if the product being purchased is not of a certain quality. Certain payment vehicles also offer users protection against the misappropriation of personal information by others, such services may also constitute a payment term. Any government related restrictions relating to the use of a specific payment vehicles (such as restrictions associated with flexible spending accounts or health savings accounts, as defined by the Internal Revenue Service) may also be a payment term. Similarly, consumer protection regulations may be a payment terms. Payment terms also can include membership assessments, annual assessments or the like associated with the user's ability to use specific payment vehicle.

In many instances, payment terms vary according to the category of an item being purchased. For instance, a credit card may provide five percent cash back for purchases of gas, and one percent cash back on all other items. A debit card may provide additional rewards points for goods purchased from specific merchants. Items that are categorized by meeting certain dollar thresholds may also vary the associated payment terms. For instance, if an item falls into a category of goods over $100, certain payment terms may apply, but if the item is in a category of goods priced at less than $100, other payment terms may apply. Similarly, items in certain categories may be subject to specific government regulations that affect payment terms. For example, some products may be eligible for purchase using a payment vehicle associated with a health savings account or a flexible spending account. In such instances, whether an item is categorized as being eligible for purchase using such funds may determine whether a specific payment vehicle can be used.

Accordingly, determining a payment vehicle to use in completing the transaction for each item based in part on the category assigned to the item 230 may be accomplished by analyzing the payment terms associated with the payment vehicles available to the user and identifying payment terms that correspond favorably to the items in the transaction. In this way, a payment vehicle can be selected for use in connection with the purchase of a given item because using that payment vehicle provides the user with the most favorable payment terms. In certain embodiments the payment terms associated with the payment vehicles available to the user will be provided by the financial institutions or merchants associated with the payment vehicles. In other embodiments, the payment terms will be dynamically collected from available sources such as a payment vehicle's terms of use, promotional offers or the like. In other embodiments, a user may be required to identify certain payment terms associated with each available payment vehicle. Once a payment vehicle is determined for the purchase of each item, the information related to the payment vehicles is communicated to a transaction device to complete the transaction 240.

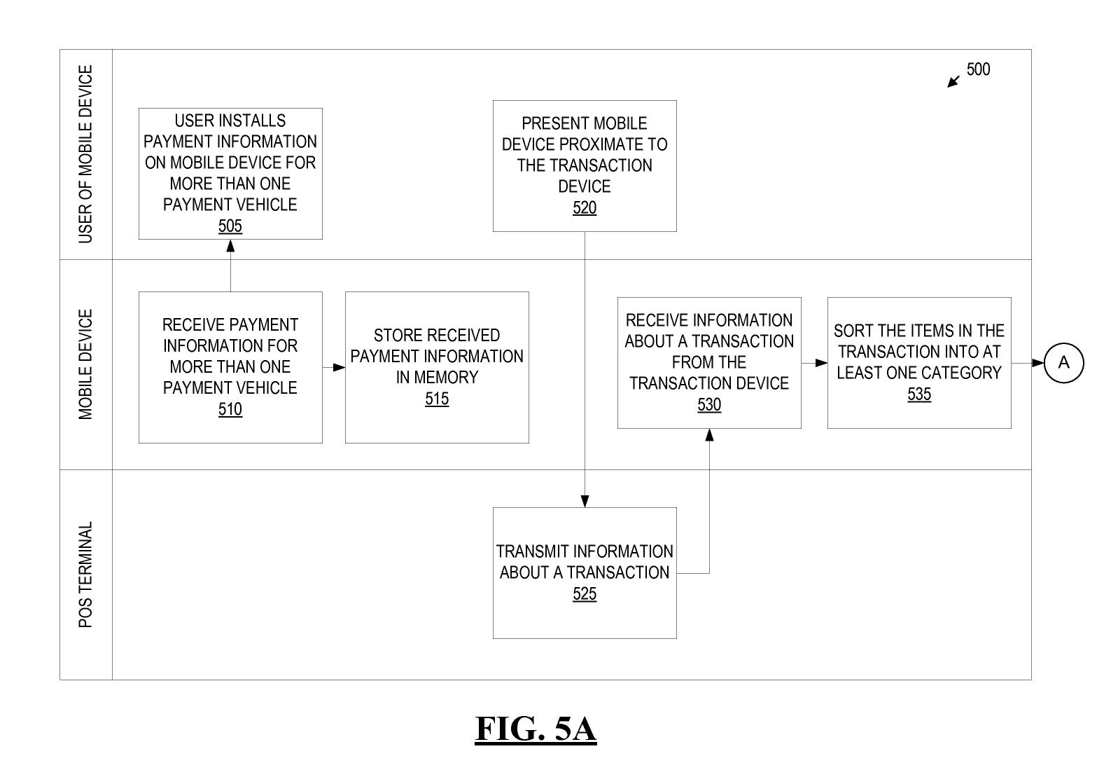

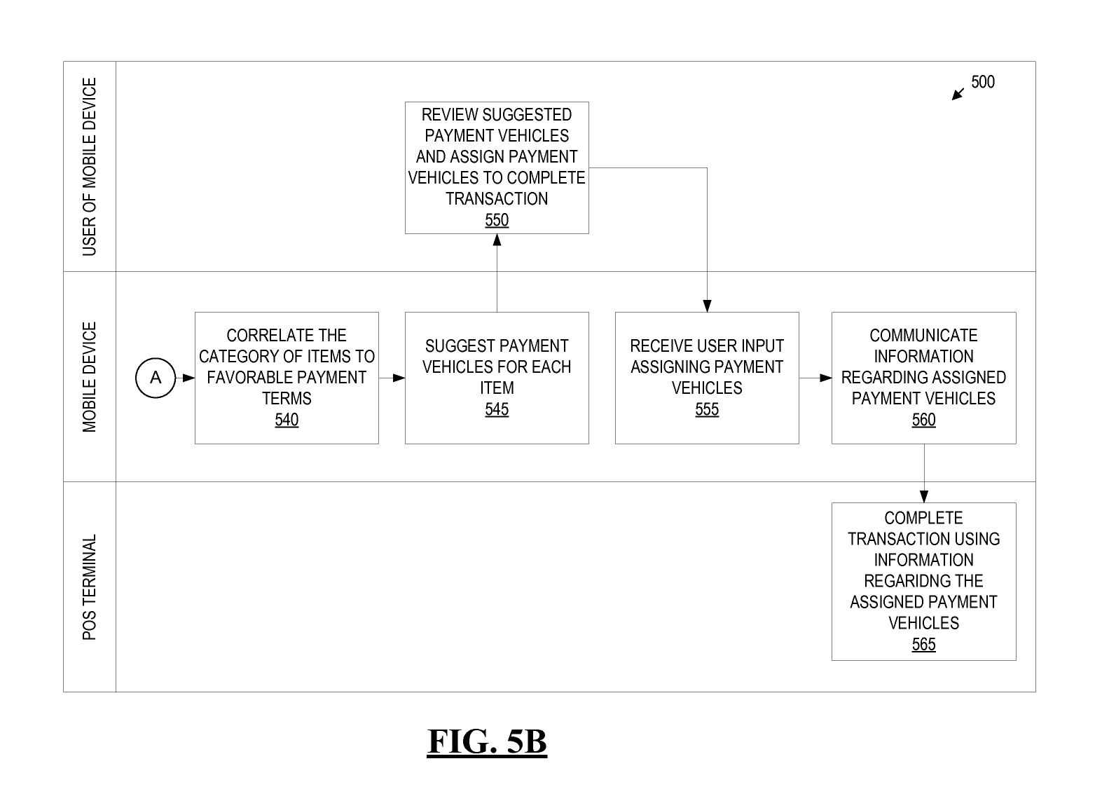

FIG. 5A provides a flow diagram illustrating a process flow 500 for the use of a system, apparatus or computer program product providing item level payment vehicle suggestions, in accordance with an embodiment of the present invention. As illustrated by block 505 the user of the mobile device installs payment information on the mobile device for more than one payment vehicle. For example, the user may first install a mobile wallet application on the mobile device to help the user manage the user's various payment vehicles on the user's mobile phone. The user may then be able to use the mobile wallet application to access, via the network, servers for each of a plurality of financial institutions in order to download payment information, e.g., encrypted account numbers, etc., associated with the one or more payment vehicles issued to the user from the financial institution. For example, a user may use her mobile phone to access Bank A and download the information needed to be able to make wireless mobile wallet payments from her checking account with Bank A. Alternatively, the user may be required to manually input information associated with a specific financial vehicle to allow the mobile wallet to utilize the financial vehicle to wirelessly transmit payments. For instance, the user may be required to input the name of the financial institution, account number and routing number to enable the mobile wallet to transmit payments form the user's checking account.

As illustrated by block 510, the mobile device receives payment information for more than one payment vehicle. In an embodiment, the mobile device receives the payment information from the user using an input device or from the financial institution server by means of a communication device. For example, the user may enter the payment information into the mobile device using the touchscreen or the mobile device may receive the payment information wirelessly over a network from the user's bank. In some embodiments, the user selects the payment information to transfer to the mobile device using the Internet.

As illustrated by block 515, the mobile device stores the received payment information in memory. In an embodiment, the received payment information for more than one payment vehicle is stored in the memory of the mobile device. For example, payment information for a credit card, debit card, gift card, checking account, store issued credit card, loyalty card and a line of credit may all be stored in the memory of a mobile phone. In certain embodiments the payment information will be encrypted or otherwise segregated in the memory to avoid access by other applications within the mobile device.

As illustrated at block 520, at some point after storing payment information for more than one payment vehicle in the memory of a mobile device, the user presents the mobile device proximate in location to a transaction device. For example, the user may bring a mobile phone with a mobile wallet application stored in the memory thereof within the range of a point-of-sale terminal at a merchant location. In some embodiments, the mobile device is configured so that it is always prepared to receive the transmission of transaction information from a transaction device. In other embodiments, the user may have activated the mobile wallet, a portion of the mobile wallet, a receiver etc. in anticipation of completing a transaction, which prepares the mobile device to receive a transmission from a transaction device. It will be understood that “proximate” is a relative term that is affected by the strength of the wireless payment network and the receiver at the transaction device.

Once the mobile device is proximate to the transaction device, the transaction device, as shown at block 525 transmits information about a transaction to the mobile device. For example, in use, a user may select a number of items off the shelves in a store and present those items at a check out location. These items may be scanned by the merchant at the check out location and the user brings her mobile device into contact with a point-of-sale terminal using near-field communication protocols. Brining the mobile device within range of the point-of-sale terminal may active a receiver within the mobile device enabling it to receive information about the transaction from the transaction device. Similarly, a user, by entering a merchant's location may enter the range of the merchant's wireless network and enable the user's mobile phone to receive information relating to a transaction using wireless protocols. The user may then shop for items which are scanned by the mobile device, e.g. through a bar code scanner, and the item level information about the items is received directly to the user's mobile device. In yet other embodiments, a merchant may generate a unique QR code after processing the items to be purchased and transmit the transaction information to the user by presenting the QR code to the user to be scanned. Regardless of the manner in which the information is transmitted, as illustrated at block 530, the mobile device receives information about a transaction from the transaction device.

As shown in block 535 the mobile device then sorts the items being purchased into at least one category. For example, the transaction device may transmit item level information about the items being purchased and indicate the user intends to purchase one large polo shirt, one pair of tennis shoes and an electric blender. In one embodiment, the mobile wallet application, or other computer program code stored in the mobile device may analyze the information about the items to be purchase and categorize the items to be purchased as being clothing, shoes and an appliance, respectively. The mobile device may also concurrently categorize the items into additional categories, such as by value, e.g. under $50, over $50 and over $100.

FIG. 5B provides a flow diagram illustrating a continuation of process 500. As illustrated by block 540 the mobile device correlates the category of the items to be purchased to favorable payment terms. For example, the mobile wallet application may acquire information regarding the payment terms associated with the various payment vehicles stored in memory at block 515 and compare the category of the items to be purchased to the payment terms. If the category of an item is associated with a favorable payment term for one or more of the available payment vehicles, as illustrated by block 545, the mobile device suggest such a payment vehicle for use in connection with that item. By way of example, if sporting equipment correlates favorably to the payment terms of a store card issued by a sporting equipment retailer, the mobile device will suggest that store card be used in connection with the purchase of any item categorized as a sporting good. In certain embodiments, the suggested payment vehicles for each item will be presented to the user via a user interface. For instance, the item to be purchased, the associated category and the recommend payment vehicle may all be presented on the display of a mobile phone.

As illustrated at block 550, the user then reviews the suggested payment vehicles and assigns payment vehicles to be used to complete the transaction. In use, the suggested payment vehicles may be presented to the user on the touch screen of a smartphone and the user can approve a suggested payment vehicle for use in the completion of the transaction by tapping the payment vehicle with her finger or a stylus. If the user does not want to accept the suggested payment vehicle, the user may assign an alternate payment vehicle for use in completing the purchase of the specific item. For instance, the user may approve the use of a credit card for the purchase of some items but indicate the she wants a checking account to be used to pay an outstanding invoice. Consistent with certain embodiments, the user may use an input device, such as a keyboard or mouse to select the alternate payment vehicle to be used with a specific item and authorize the transaction with the revised payment vehicles.

As shown at block 555, the mobile device receives the user input assigning payment vehicles. For example, if the user utilizes the user interface connected to the mobile device, the mobile device will directly receive the user input assigning payment vehicles. At block 560, the mobile device communicates information regarding the assigned payment vehicles. For example, a transceiver in a mobile phone may wirelessly transmit the user's credit card information, debit card information, and the routing numbers associated with the user's savings account to a cash register. As another example, the mobile device may generate a unique QR code with the necessary information for multiple payment vehicles and the merchant system may scan the generated QR code. As represented by block 565, the transaction device completes the transaction using the information regarding the assigned payment vehicles. For instance, if the mobile device generates a unique QR code with the payment information for each of the assigned payment vehicles and the merchant system scans the code the transaction device may communicate with a financial institution server to provide the necessary information and authorization to initiate the transfer of funds from the user's accounts to the merchant. Similarly, the mobile device may wirelessly transmit payment instructions and authorizations to the financial institution server associated with the issuer of a debit card, and the financial institution server associated with a line of credit held by the user and provide confirmation to the transaction device that the necessary funds have been transferred.

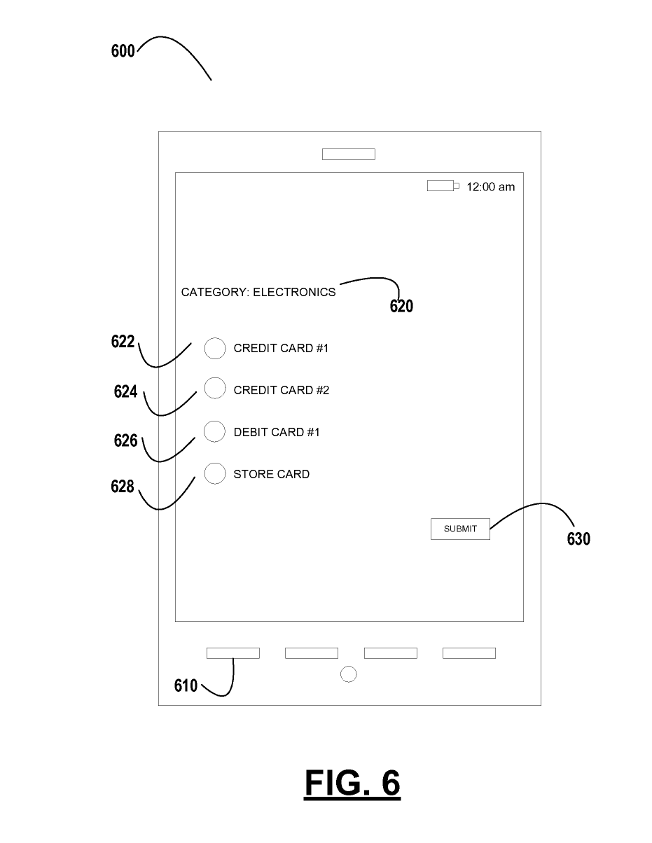

Referring now to FIGS. 6-8, a series of exemplary display pages 600, 700 and 800 of a mobile device 105 for providing item level payment vehicle suggestion are provided consistent with an embodiment of the present invention are provided. It will be understood that in some embodiments, each of the pages 600, 700 and 800 are displayed on the user interface 150 of the mobile device 105. It will also be understood that the mobile device 105 is configured, in some embodiments to navigate from page 600 to page 700, page 700 to page 800, page 600 to page 800 and/or vice versa either by actuating one of the buttons (e.g. 610, 710, 840) or one of the other input devices of the user interface 150. It will be further understood that the display pages 600, 700 and 800 can be embodied as portions of the mobile wallet application 124, as Internet web pages and/or the like. In addition, it will be understood that, in some embodiments, the apparatus, system or computer program product having the process flows 200, 300, 400 and 500 are configured to implement any one or more of the embodiments of the present invention described and/or contemplated herein in connection with the display pages 600-800.

Referring now to FIG. 6, it will be understood that in some embodiments the display page 600 is displayed in connection with determining a payment vehicle to use in connection with the purchase of an item according to predetermined user defined preferences, as represented by block 410 of a system with the process flow 400. Alternatively, the display page 600 is displayed after the customer navigates to the page from another display pages, such as display pages 700 or 800. As shown, in this embodiment, the display page 600 includes a line presenting a category 620, radio buttons 622-628 enabling a user to associate an available payment vehicle to the identified category of items and a Submit button 230. In such an embodiment, the payment vehicles displayed on the display page 600 will be the payment vehicles available to the user (e.g. the payment vehicles stored in the memory 120 of the mobile device 105 of FIG. 1). In the embodiment shown, the category of items presented is “electronics” 620. If the user prefers to use the Credit Card #1 in connection with transactions involving items categorized as electronics, the user actuates button 622. Similarly, if the user prefers to use Credit Card #2 in connection with the purchase of electronics items the user actuates button 624. Once the user has identified the payment vehicle she prefers to use with the identified category, the user actuates the Submit button 630 and the mobile device will store the user's preferred payment vehicle for use in connection with transactions involving items in the identified category. In certain embodiments, after the user submits the payment vehicle preferences for a given category of item, another category of item will be presented until the user has associated at least one payment vehicle with each type of category known to the mobile device. It will be understood that in some embodiments the user may select more than one payment vehicle for use in connection with the purchase of a given category. The specific category of items and the payment vehicles shown in display page 600 are for illustrative purposes and it will be understood that the category and the particular payment vehicles may vary.

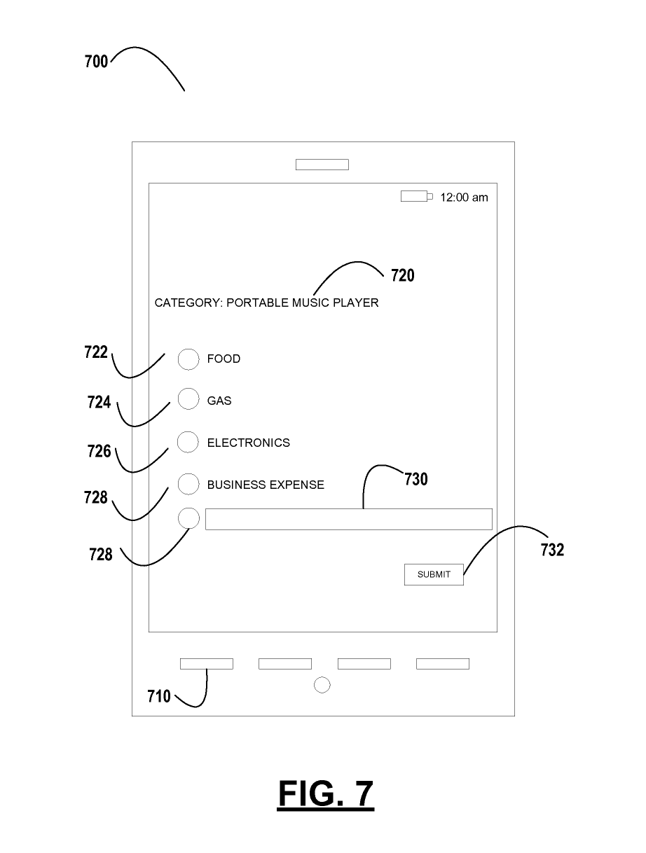

Referring now to FIG. 7, the display page 700 may be displayed in connection with assigning any item in a transaction to at least one category by receiving a user designation, as represented by block 320 of the process flow 300 in FIG. 3. Alternatively, the display page 700 is displayed after the user navigates to the page from another display page, such as display page 600 or 800. As shown, in this embodiment, the display page 700 includes a line presenting item level information about an item involved in a transaction 720, radio buttons 722-728 enabling a user to associate the identified item with a category, a box 730 for inputting a user defined category for the item and a Submit button 732. In the embodiment shown, the item in the transaction is a “portable music player” 720. In such an example, the user may actuate the radio button 726 associated with the electronics category. Alternatively, if for example the portable music player is required for work, or serves some health purpose, the user may actuate the radio button 728 and enter “work expense” or “healthcare” respectively in the box 730. Once the user has identified the category or categories of items she wants to associate with the identified item, the user actuates the Submit button 732 and the item will be assigned to the identified category. In some embodiments, once the user actuates the Submit button 732 and assigns and item to a given category, the next item in the transaction is presented to the user to be assigned to a category. This process may continue until all of the items included in the transaction have been assigned to a category. It will be understood that in some embodiments the user may select more than one category for an item. It will also be understood that the specific item and the identified categories in the embodiment shown on display page 700 are illustrative only and may include other items and/or categories.

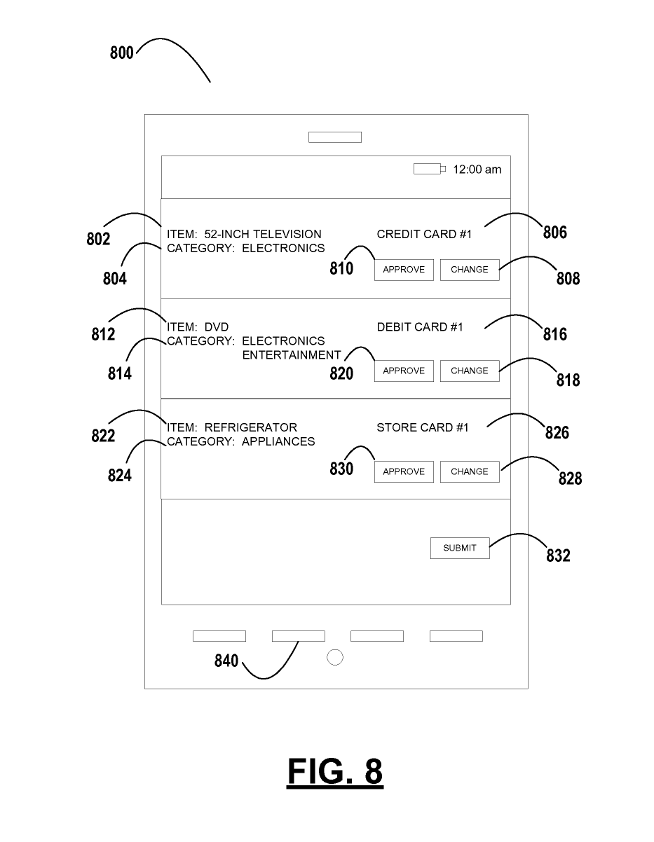

Referring now to FIG. 8, the display page 800 may be displayed in connection with reviewing suggested payment vehicles and assigning payment vehicles to complete a transaction, as represented by block 550 of the process flow 500 in FIG. 5B. Alternatively, the display page 800 is displayed after the user navigates to the page from another display page, such as display page 600 or 700. As shown, in this embodiment, the display page 800 includes lines displaying item level information about items in a transaction 802, 812, 822, categories assigned to the items 804, 814 and 824, suggested payment vehicles for use completing the transaction 806, 816, 826, Approve buttons for authorizing a transaction using the identified payment vehicle 810, 820, 830, Change buttons 808, 818, 828 to enable the user to assign an alternate payment vehicle and a Submit button 832 for authorizing the completion of the transaction. In the embodiment shown, three items have been identified as being a part of the transaction: a 52-inch television 802 a DVD 812 and a Refrigerator 822. The television 802 is assigned to the category electronics 804. The DVD 812 is assigned to the categories electronics and entertainment 814. The refrigerator 822 is assigned to the category appliances. As shown in display page 800 the mobile device (e.g. the mobile wallet application 124 stored in the memory 120 of the mobile device 105) suggests using Credit Card #1 806 for the television 802, Debit Card #1 816 for the DVD 812 and Store Card #1 826 for the refrigerator 822. In such an example, the user may indicate that she approves using the Credit Card #1 806 to complete the transaction as it relates to the television 802 by actuating the Approve button 810. Similarly, the user may approve the use of Debit Card #1 816 for the DVD 812 by actuating the Approve button 820 and use of the Store Card #1 826 for the refrigerator 822 by actuating the Approve button 830. In the alternative, if the user wants to override the suggestion of the specific payment vehicle the user may actuate one of the change buttons 808, 818 or 828. For instance, if the user is aware that she can receive a greater discount for use of the particular DVD 812 being purchased if Store Card #1 is used, the user may actuate the Change button 818. Actuating a Change button 808, 818 or 828 will navigate the user to an alternate display page (not shown) that in some embodiments will be similar to the display page 600 enabling the user to select an alternate payment vehicle to use to complete the transaction. In the current example, the user may actuate the Change button 818 and select the Store Card #1 826 to use in the transaction. In some embodiments, after the user has actuated an Approve button (e.g. 810, 820, 830) associated with all of the identified items, the completion of the transaction will be automatically approved and the mobile device will communicate the necessary payment vehicle information to the transaction device (see e.g. block 560 of FIG. 5B). In other embodiments, the user must actuate the Submit button 832 to initiate the communication of payment information to the transaction device. In yet further embodiments, the user may not be required to actuate the Approve buttons 810, 820 or 830 to approve the suggested payment vehicles and can accept the suggested payment vehicles for all items by actuating the Submit button 832. It will be understood that the specific items, categories and payment vehicles in the embodiment shown on display page 800 are illustrative only and may include other items, categories and/or payment vehicles. It will also be understood that display page 800 may display information for a plurality of items, not just three as shown, and that if the number of items can not all be displayed concurrently on the display of a mobile device that the user can move to additional items by scrolling to the items not initially presented on the display page.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages. In some embodiments, the one or more computer-executable program code portions for carrying out operations of embodiments of the present invention are written in conventional procedural programming languages. The computer program code may alternatively or additionally be written in one or more multi-paradigm programming languages

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

1. A system comprising:
a user interface configured to receive input from a user and to display information to the user;
a communication device configured to transmit and receive information from a transaction device;
a memory comprising information related to more than one payment vehicles stored therein; and
a processor communicably coupled to the user interface, the communication device and the memory, wherein the processor is configured to operate computer instruction code to:
receive information about a transaction, wherein the information comprises item level information about at least two items in the transaction;
assign the items in the transaction to at least a first item category and a second item category based on the item level information about the items, wherein the first item category and the second item category are based on a use of the items;
determine a payment vehicle to use in completing the transaction for the first item category and a payment vehicle to use in completing the transaction for the second item category; and
use the communication device to transmit to the transaction device the information related to the first payment vehicle and the second payment vehicle determined for use in completing the transaction for each item.

2. The system of claim 1, wherein receiving information about a transaction is accomplished by near-field communication, radio frequency identification, wireless communication protocols, QR codes, universal product codes, bar codes or magnetic code.

3. The system of claim 1, wherein assigning the items in the transaction to at least one category comprises receiving a category designation for the items from a merchant

4. (canceled)

5. The system of claim 1, wherein assigning the items in the transaction to at least one category comprises using the item level information about the items in the transaction to associate the items with a category in preexisting databases.

6. The system of claim 1, wherein assigning the items in the transaction to at least one category comprises determining the location of the transaction and using the location of the transaction and the item level information about the items in the transaction to assign the items to at least one category.

7. The system of claim 1, wherein determining a payment vehicle to use in connection with the purchase of the items based in part on the category assigned to the items comprises comparing the assigned categories to predetermined user defined preferences about what payment vehicle to use for different categories of items.

8. The system of claim 1, wherein determining a payment vehicle to use in completing the transaction for each item based in part on the category assigned to the items comprises:
analyzing the payment terms associated with the payment vehicles available to the user; and
identifying payment terms that correspond favorably to categories in the transaction.

9. The system of claim 8, wherein payment terms are reward terms, cash back terms, credit rates, merchant terms, product warranty terms, dispute resolution terms, consumer protection regulations, transaction costs, terms regarding protection against misappropriation of information, membership assessments, regulatory terms or incentives.

10. The system of claim 1, wherein using the communication device to transmit to the transaction device the information related to the determined payment vehicles comprises:
presenting information to the user, via the user interface, the payment vehicle determined for use in completing the transaction for each item;
receiving input from the user approving the completion of the transaction using the determined payment vehicle for each item or assigning an alternate payment vehicle for use with one or more items;
using the communication device to transmit the information related to the approved payment vehicles to complete the transaction.

11. The system of claim 1, wherein using the communication device to transmit to the transaction device the information related to the determined payment vehicles involves a single transaction.

12. A computer program product, comprising
a non-transitory computer-readable medium having computer-executable code stored thereon, the computer executable code comprising:
a first code portion stored in the memory and configured to receive information about a transaction, wherein the information comprises item level information about at least two items in the transaction;
a second code portion stored in the memory and configured to assign the items in the transaction to at least a first item category and a second item category based on the item level information about the items, wherein the first item category and the second item category are based on a use of the items;
a third code portion stored in the memory and configured to determine a payment vehicle to use in completing the transaction for the first item category and a payment vehicle to use in completing the transaction for the second item category; and
a fourth code portion stored in the memory and configured to transmit to the transaction device information related to the first payment vehicle and the second payment vehicle determined for use in completing the transaction for each item.

13. The computer program product of claim 12, wherein the first code portion is configured to receive information about a transaction through the use of near-field communication, radio frequency identification, wireless communication protocols, QR codes, universal products codes, bar codes or magnetic codes.

14. The computer program product of claim 12, wherein the second code portion is configured to assign the items in the transaction to at least one category by receiving a category designation for the items from a merchant.

15. (canceled)

16. The computer program product of claim 12, wherein the second code portion, in assigning the items in the transaction to at least one category, is further configured to use the item level information about the items in the transaction to associate the items with a category in preexisting databases.

17. The computer program product of claim 12, wherein the second code portion, in assigning the items in the transaction to at least one category, is further configured to determine the location of the transaction and use the location of the transaction and the item level information about the items in the transaction to assign the items to at least one category.

18. The computer program product of claim 12, wherein the third code portion in determining a payment vehicle to use in completing the transaction for each item based in part on the category assigned to the items is further configured to compare the assigned categories to predetermined user defined preferences about what payment vehicle to use for different categories of items.

19. The computer program product of claim 12, wherein the third code portion in determining a payment vehicle to use in completing the transaction for each item based in part on the category assigned to the items is further configured to analyze the payment terms associated with the payment vehicles available to the user and identify payment terms that correspond favorably to the categories in the transaction.

20. The computer program product of claim 19, wherein payment terms are reward terms, cash back terms, credit rates, merchant terms, product warranty terms, dispute resolution terms, consumer protection regulations, transaction assessments, terms regarding protection against the misappropriation of information, membership assessments, regulatory terms or incentives.

21. The computer program product of claim 12, wherein the fourth code portion, in transmitting to the transaction device information related to the payment vehicles determined for use in completing the transaction for each item, is further configured to present information to the user, via a user interface, the payment vehicle determined for use in completing the transaction for each item, receive input from the user approving the completion of the transaction using the determined payment vehicle for each item or assigning an alternate payment vehicle for use with one or more items and transmit to the transaction device the information related to the approved payment vehicles to complete the transaction.

22. A method for categorizing items in a transaction and selecting a payment vehicle with favorable payment terms to complete the transaction, comprising:
storing information related to more than one payment vehicles in the memory of a mobile device;
determining that the the mobile device is proximate to a transaction device;
receiving information about a transaction, wherein the information comprises item level information about at least two items in the transaction;
assigning the items in the transaction into at least a first item category and a second item category based on the item level information about the items, wherein the first item category and the second item category are based on a use of the items;
determining a payment vehicle to use in completing the transaction for the first item category and a payment vehicle to use in completing the transaction for the second item category; and
transmitting the information related to the first payment vehicle and the second payment vehicle from the mobile device to the transaction device for use in completing the transaction for each item.

23. The method of claim 22, wherein transmitting the information related to the payment vehicles is completed through the use of near-field communication, radio frequency identification, wireless communication protocols, QR codes, universal products codes, bar codes or magnetic codes.

24. The method of claim 22, wherein correlating the category of the items to favorable payment terms further comprises:
identifying payment terms for the more than one payment vehicles stored in the memory of the mobile device that vary according to the category of the items in the transaction;
comparing the payment terms for each of the more than one payment vehicles for each of the items in the transaction; and
determining the payment vehicle with the most favorable payment terms for each of the categories in the transaction.

25. (canceled)
